(19) United States
(12) Patent Application Publication
(10) Pub. No.: US 2025/0065632 A1
(43) Pub. Date: Feb. 27, 2025

(54) PRINT HEAD HEALTH DETERMINING DEVICE AND METHOD

(71) Applicant: Canon Production Printing Holding B.V., Venlo (NL)

(72) Inventors: Pawel Oortwijn, Venlo (NL); Remco HAMMEN, Venlo (NL); David RIEDEL, Venlo (NL)

(73) Assignee: Canon Production Printing Holding B.V., Venlo (NL)

(21) Appl. No.: 18/812,376

(22) Filed: Aug. 22, 2024

(30) Foreign Application Priority Data
Aug. 24, 2023 (EP) 23193115.5

(51) Int. Cl. B41J 2/165; B41J 29/00

(52) U.S. Cl. CPC B41J 2/16579; B41J 29/00

(57) ABSTRACT

Print head health determining device, comprising: a print head interface for connecting to a print head or log server and obtaining status information with regard to the print head, a data processing device connected to the print head interface and configured to process the print head status information and determine a print head health, and an output interface connected to the data processing device and configured to output the print head health, and wherein the print head status information comprises one or more of: nozzle acoustic feedback information, information on the prior usage of expired ink, and nozzle failure detection information.

### CROSS REFERENCE TO RELATED APPLICATIONS

This application claims priority under 35 U.S.C. § 119(a) to application Ser. No. 23/193,115.5, filed in Europe on Aug. 24, 2023, the entire contents of which is hereby incorporated by reference into the present application.

### BACKGROUND OF THE INVENTION

### Field of the Invention

The present invention generally pertains to a print head health determining device. The present invention also pertains to a printer controller comprising such a print head health determining device. The present invention further pertains to a printer fleet management server comprising such a print head health determining device.

Furthermore, the present invention pertains to a method for determining the health of a print head. The invention also pertains to a computer program product that performs such a method.

### BACKGROUND OF THE INVENTION

It is known that print heads as used in inkjet printers are prone to the occurrence of issues that may degrade the image quality of the images printed with the print heads. Some of these issues can sometimes be resolved or mitigated by specific actions, for example nozzles in the print head being clogged by dried out ink may be opened up by maintenance actions such as flushing the print heads. Other issues may have a more permanent character, for example a wrinkled edge of the print media may collide with the print head and permanently damage a number of nozzles, or the nozzle plate. Some issues, permanent or temporary, may be compensated for. For example, a nozzle that fails to jet may be compensated by having a neighbouring nozzle jet instead without the print result being visually impacted. Over time permanent issues will accumulate and although the print quality will initially remain (almost) unaffected, at some point print quality will start to suffer.

An issue with print quality is that there is quite an amount of subjectivity connected to print quality. Some print quality issues will be observable, but not everybody will necessarily notice them all. Even in case of trained eyes, some print quality issues will be quite obtrusive in one print, but unnoticeable in other prints. Therefore, the print industry has developed several tests to more or less objectively judge print quality by printing specifically designed test patterns and measuring the occurrence of artefacts specific for those test patterns.

A disadvantage of the known test methods is that they only measure one or sometimes a few metrics, such as greyness uniformity, banding, etc. To get a good impression of the overall print quality a print head can (still) deliver many test patterns have to be printed and measured. This takes time and therewith production time is lost due.

The object of the present invention is to provide a method of determining a print head's health while limiting the loss of productivity.

### SUMMARY OF THE INVENTION

The object of the invention is obtained by a print head health determining device, comprising: a print head interface for connecting to a print head or a log server and obtaining status information with regard to the print head, a data processing device connected to the print head interface and configured to process the print head status information and determine a print head health, and an output interface connected to the data processing device and configured to output the print head health, and wherein the print head status information comprises one or more of: nozzle acoustic feedback information, information on the prior usage of expired ink, and nozzle failure detection information.

The print head interface may be any interface that allows the print head to be connected and the internal memory of the print head to be read, or the print head's embedded controller to be interrogated to thus obtain status information describing the print heads status.

The data processing device may be any device or circuit that is appropriately programmed or arranged to process the print head status information and determine the print head's health from the status information.

The output interface may be any device that is appropriately arranged to communicate the determined print head status to either a user, such as a printer operator or a service engineer, or an external system that is arranged to take further action on the status. For example, the external system may be a service scheduling system that schedules a service visit to the printer to have the print head replaced.

The print head health output by the output interface may comprise a binary status (for example “okay”/“not okay”), multiple discrete statuses (for example “okay”, “malfunction suspected”, “malfunction”), or a health score in some numeric range (for example 0-100%). Furthermore, the print head health status being output may comprise a specific recommendation for action, for example “replace print head”.

The print head status information is information with regard to the status of the print head that is gathered during normal operation of the print head, during print head maintenance operations, and diagnostics information stored during the performance of diagnostics operations. The print head status information may also comprise static information (for example a model number and a serial number), and information relating to an installation of the print head (for example brand and model of the printer it was installed in, installation time, etc.)

Nozzle acoustic feedback information is status information about a nozzle that is being collected by examining a nozzle's response to being actuated (jetting or non-jetting). For example, in a MEMS (microelectromechanical system) print head a piezo element is used to jet ink out of nozzle orifice that is connected to an ink chamber, the piezo element forming a wall of the ink chamber. Applying an electrical pulse to the piezo element will cause the piezo element to deform creating a pressure wave in the ink chamber resulting in a droplet of ink being jetted out of the nozzle. The piezo element also works in reverse: a pressure wave in the ink chamber will cause the piezo element to deform and result in an electrical pulse. Measuring this electrical pulse after the nozzle has been actuated, or even during the actuation if the ink chamber comprises more than one piezo element), provides information on the state of the nozzle. For example, the acoustic behaviour of an open nozzle orifice is quite different from a clogged nozzle orifice. Print heads may store the last number of states of each nozzle to allow the printer to take action. For example, suggest a maintenance action, or compensate for a failing nozzle.

Not only does the nozzle acoustic feedback information indicate the state of the individual nozzles, but the state of several nozzles provides information on the status of the nozzle plate. For example, if incorrect print media is loaded into the printer, the actual print media being much thicker than the printer expects, the print gap may be too small and the print head may collide with the print media resulting in the nozzle plate coming partly loose from the print head body. This typically results in a range of nozzles becoming deformed or even obstructed.

In a further embodiment according to the invention a print head health determining device is provided, wherein the nozzle acoustic feedback information comprises for at least part of the nozzles of the print head a most likely nozzle state out of a multitude of nozzle states for a nozzle, including at least one state denoting normal jetting behaviour and at least one state denoting a failure state, and wherein the number of occurrences of one or more failure states is used to determine the print head health.

An increasing number of nozzles failing will result in the print quality degrading. If the number of nozzles with a failure state is too high, for example exceeds a predetermined threshold, the print quality will no longer be acceptable. More importantly though, as mentioned above, a large number of nozzles failing often indicates that the nozzle plate has collided and might even be partly loose.

In a further embodiment a predetermined number of last non-calibration prints is taken and the number of failure states during this number of prints is considered.

In another embodiment according to the invention a print head health determining device is provided, wherein the failure states comprise at least one of: an open circuit (“open”) state, an air at nozzle (“air”) state, and a deviating nozzle (“dev”) state.

An open circuit state indicates that the acoustic feedback registered actually corresponds to not having received any significant signal. This typically happens when the nozzle channel is completely empty. In other words, there is no ink to cause any acoustic behaviour.

The air at nozzle state denote that there is some air in the nozzle channel.

Deviating nozzle denotes that the feedback is deviating from normal jetting but is different from an open circuit, or air at nozzle state. This may still be a—although weaker—indication that there is air somewhere inside the nozzle channel.

In another embodiment according to the present invention a print head health determining device is provided, wherein the nozzle state of only a predetermined number of outer nozzles of a print head are considered for determining the print head health.

This embodiment is particularly advantageous for detecting damage to the nozzle plate and in particular a (partly) loose nozzle plate. Print media colliding with the print head will typically strike one end of the print head first resulting in the most excessive damage at that side. For example, only the sixteen outer nozzles on one end of a 256-nozzle print head and the sixteen outer nozzles on the other end are considered for detecting a loose nozzle plate.

In another embodiment according to the invention a print head health determining device is provided, wherein the print head health is based on a weighted sum of the occurrences of the failure states in one or more swaths exceeding a predetermined threshold.

Some of the nozzle failure states are a more clear indication of a loose nozzle plate than others. For example, the open circuit state is a quite strong indication of a loose nozzle plate, whereas a deviating nozzle is only a very weak indication. By calculating a weighted sum of the occurrences of the states, this is taken into account.

In another embodiment according to the invention a print head health determining device is provided, wherein if the information on the prior usage of expired ink indicates that the print head has been used with expired ink, the print head health is determined as non-optimal.

Aged ink is no longer guaranteed to have properties that are within acceptable ranges for the print head (or the printers ink handling system). Aged ink may acoustically behave differently and thus jet differently. More importantly, it may clog print head nozzles and this clogging may be permanent. Ink containers are typically provided with machine readable codes or machine readable data storages that allow a printer to read an expiration date. If an operator forces printing with expired ink, the print head concerned may store the usage of expired ink in its internal storage. Even if the print head is removed from the printer and used again in (another) printer, the print head health determining device will flag the print head as having non-optimal health status.

In a further embodiment according to the invention a print head health determining device is provided, wherein the nozzle failure detection (NFD) information comprises a number of print head nozzles that is failing, and if it is determined that the number of failing nozzles or the number of uncompensatable nozzles that remain after applying nozzle failure correction (NFC) exceeds a threshold, determining a print head health as non-optimal.

The nozzle failure detection may be based on the nozzle acoustic feedback information, or based on other known nozzle failure detection methods such as analysis of a digital image acquired of the printed image by means of an inline scanner deposited downstream of the image forming unit comprising the print heads. Nozzle failure correction attempts to compensate for failing nozzles by having alternative nozzles jet instead of the failing nozzle, typically neighbouring nozzles, or—in multi-pass printing systems—a nozzle that passes the same spot on the media during another pass. Nozzle failure correction techniques may also have neighbouring nozzles jet larger droplets to compensate for a failing nozzle.

Nozzle failure correction can not compensate for all cases of failing nozzles. For example: if multiple adjacent nozzles are failing—which is a likely scenario in case of mechanical damage to the nozzle plate—there are no neighbouring nozzles left for all failing nozzles and it becomes unavoidable that the failing nozzles will result in print quality issues.

If the number of nozzles that are failing and that can no longer be compensated through the nozzle failure correction algorithm exceeds a predetermined number, the print head health is considered non-optimal and replacement of the print head should be considered.

According to another embodiment, a printer controller is provided comprising such a print head health determining device. The printer controller may be integrated into the printer, but may also be a device external to the printer and connected to the printer to control the printer.

In an alternative embodiment the print head health determining device is embodied in a service laptop of a service engineer. The service engineer may connect the service laptop to a printer to determine the health status of the print heads of the printer.

In a specifically advantageous embodiment, the present invention provides a printer fleet management server comprising such a print head health determining device. The printer fleet management server may be located at the site where the printers are located, managing the local printer fleet, but may also be a regional or global printer fleet management server, for example, operated by the manufacturer of the printers being managed. This has the further advantage that upon a customer of the manufacturer reporting issues with print quality—or even without such a report, for example in preparation of a periodical service visit—the manufacturer can remotely see whether a print head health status is non-optimal and replacement of the print is to considered in preparation of the service visit.

In a first aspect of the invention a method is provided for determining the health of a print head, comprising the steps of: obtaining status information from a print head, processing the print head status information determining a print head health, and outputting the print head health, and wherein the print head status information comprises one or more of: nozzle acoustic feedback information, information on the prior usage of expired ink, and nozzle failure detection information.

In a further aspect a method is provided, wherein the nozzle acoustic feedback information comprises for at least part of the nozzles of the print head a most likely nozzle state out of a multitude of nozzle states for a nozzle, including at least one state denoting normal jetting behaviour and at least one state denoting a failure state, and wherein in the processing step the number of occurrences of one or more failure states is used to determine the print head health as non-optimal as the nozzle plate has probably come loose.

In again a further aspect of the invention a method is provided, wherein the failure states comprise at least one of: an open circuit (“open”) state, an air at nozzle (“air”) state, and a deviating nozzle (“dev”) state.

In a further aspect a method is provided, wherein the nozzle state of only a predetermined number of outer nozzles of a print head are considered for determining the print head health.

In again a further aspect a method is provided, wherein the print head health is based on a weighted sum of the occurrences of the failure states in one or more swaths exceeding a predetermined threshold.

In another aspect of the invention a method is provided, wherein if the information on the prior usage of expired ink indicates that the print head has been used with expired ink, the print head health is determined as non-optimal.

In again another aspect of the invention a method is provided, wherein the nozzle failure detection (NFD) information comprises a number of print head nozzles that is failing, and if it is determined that the number of failing nozzles or the number of uncompensatable nozzles that remain after applying nozzle failure correction (NFC) exceeds a threshold, determining a print head health as non-optimal.

In another embodiment of the invention a computer program product is provided that is embodied on a non-transitory computer readable medium that, if executed on a processor connected to a print head, performs the steps of any of the above methods.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description. The scope of the invention is therefore determined by the claims below.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1 shows a diagram of an embodiment of the present invention being connected to a print head to be examined.

FIG. 2 shows a diagram of an exemplary hardware embodiment of the present invention.

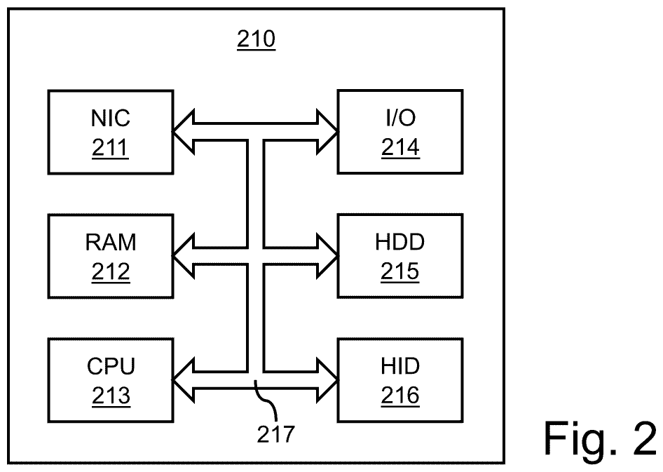

FIG. 3 shows a flow chart of an exemplary method according to the invention.

FIG. 4 shows in more detail a step from the flow chart of FIG. 3.

### DETAILED DESCRIPTION OF THE PREFERRED EMBODIMENTS

The present invention will now be described with reference to the accompanying drawings, wherein the same reference numerals have been used to identify the same or similar elements throughout the several views.

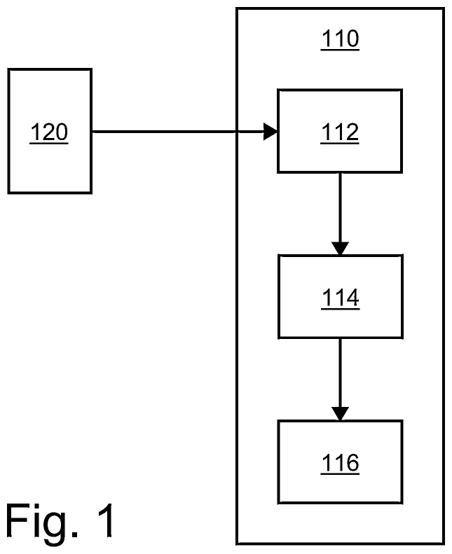

A print head 120 (FIG. 1) to be examined for its health status is connected to the print head health determining device 110, or more particularly to the print head interface 112 of the print head health determining device 110. This connection may be a direct connection, or an indirect connection.

The print head health determining device 110 may take the form of a service laptop or tablet that is either directly connected to the print head, or alternatively connected to an embedded print engine controller or to a printer controller, wherein the embedded print engine controller or the printer controller allows the service laptop or tablet to access the print head status information in the print head 120.

The print head health determining device 110 may also be an integral part of an embedded print engine controller, or a printer controller.

A direct connection may utilise a dedicated service port on the print head 120 or a control port normally used for controlling the print head 120 during its operation.

In an advantageous embodiment the print head health determining device 110 is embodiment in a fleet management server managed by a printer manufacturer or a printer service organisation. In such a situation the printer manufacturer or printer service organisation may monitor the health status of the print heads 120 installed in the printers of its customers and appropriately schedule a service visit to replace a print head 120 that is no longer operating as expected. In such an embodiment the connection between the print head 120 and the print head health determining device 110 involves a connection over the internet.

In the case of a direct connection the connection may take the form of a serial or parallel bus. In such a case the print head interface 112 is formed by a serial or parallel port and some appropriate software code executed in a processor to send the appropriate commands to the print head 120 and to interpret the responses from the print head 120.

In the case of an indirect connection, the print head interface 112 may take the form of a Network Interface Controller (NIC) that connects through the internet to a printer controller of the printer comprising the print head 120, and through appropriate programming of the controller of the print head health determining device 110 sends commands to and receives responses from the print head 120.

In some cases the print head status information may comprise a lot of information. Especially when for example nozzle acoustic feedback is stored for all nozzles during multiple swaths, or even multiple prints, the amount of data may exceed the internal storage of the print head. In such a case it is advantageous to log this information or part thereof to a log external to the print head, for example to a log in the printer controller, or to a log in a fleet management server. The latter is especially advantageous if the latter also comprises the print head health determining device. Retrieving the print head status information therefore comprises directly retrieving the information from the print head, but also retrieving the information from such an external log, or retrieving part from the external log and the remainder from the print head itself.

The print head status information received through the print head interface 112 is processed by the data processing device 114. Analysis of the received status information takes place and a print head health is determined. The data processing device 114 may be implemented as discrete logic components, but is more advantageously implemented in the form of programmable logic, for example a Field Programmable Gate Array (FPGA), a microcontroller, or a central processing unit (CPU).

The print head health determined by the data processing unit 114 is provided to the output interface 116 to take appropriate action upon the determined print head health. The output interface 116 make take the form of an integrated display in the print head health determining device 110, such as in the case of an integrated display of a service laptop or service tablet. Alternatively, the output interface 116 is for example a NIC to send a message to a service scheduling server to inform the server of a service visit to be scheduled for the printer comprising the print head 120.

The print head health determining device 110 is preferred to be implemented as an off-the-shelf computer 210 comprising NIC 211 to communicate over a network with other device. The NIC 211 may implement the hardware part of the print head interface 112 to communicate via the internet with a printer controller comprising the print head 120. This communication by the NIC 211 happens under the control of a CPU 213 that is responsible for processing the data in the computer 210 and that controls the other components 211-217 of the computer 210. In case of a direct connection to the print head, instead of the NIC 211 the CPU 213 might control I/O 214 to communicate with the print head 120. The I/O may take the form of an Universal Serial Bus (USB).

The CPU 213 receives the print head status information through the NIC 211 (or I/O 214) and stores it temporarily in a Random Access Memory (RAM) 212 as the CPU 213 typically only has a limited amount of data storage. The CPU 213 processes the print head status information storing intermediate results in the RAM 212 too, and finally produces a print head health that is temporarily stored in RAM 212 too.

Once the print head health has been determined it is output to a Human Interface Device (HID) 216 such as a display, for example in the case of a service engineer using a service laptop to examine the health of the print head, or alternatively the print head health is output through the NIC 211 to a service scheduling server in case the computer 210 is a fleet management server. As the RAM 212 is a volatile data storage, meaning it will loose all stored data if it loses power, the computer 210 further comprises a non-volatile storage 215 to store information in a permanent manner, for example in the form of a Read-Only Memory (ROM) and/or a Hard Disk Drive (HDD) or Solid-State Drive (SSD). The print head status information may be stored in the non-volatile storage 215 for later retrieval, as well as the determined print head health. Furthermore, the non-volatile storage 215 comprises the program code loaded and executed by the CPU 213 to make the computer 210 to operate and perform its typical functions as a computer (for example the Operating System (OS)) as well as the functions described in here in relation to the invention.

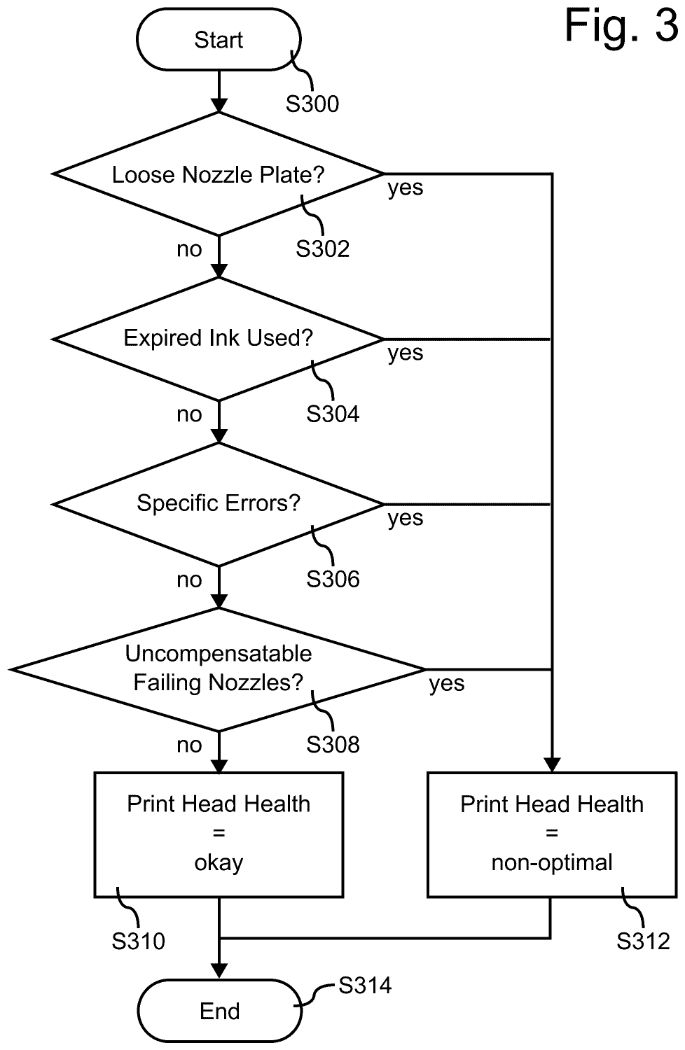

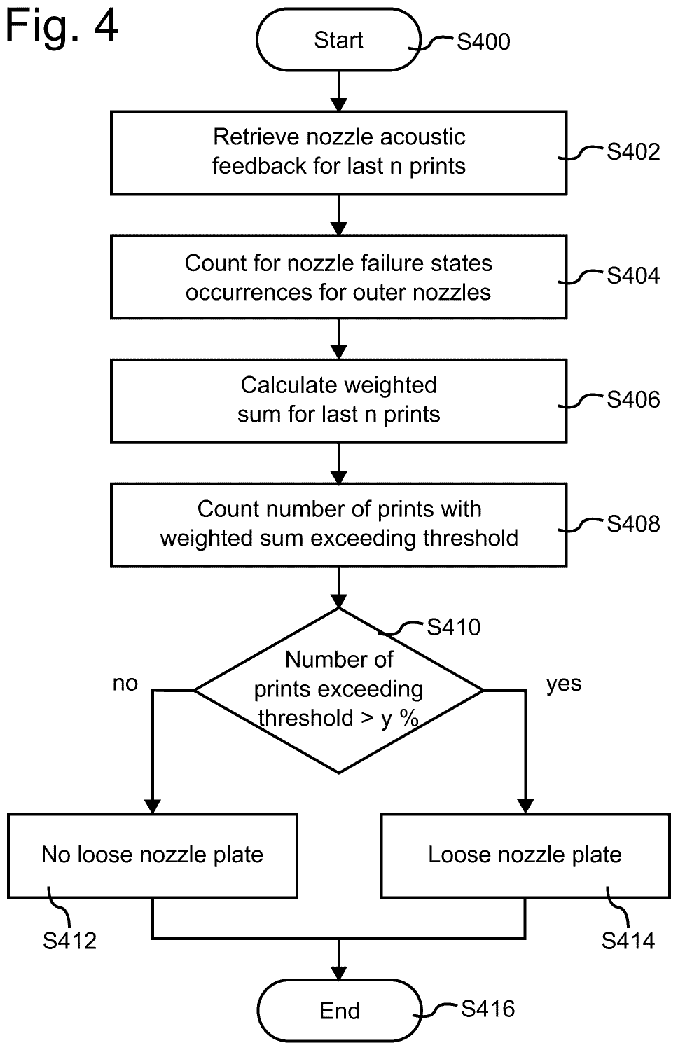

One specific method for determining the health of a print head may comprise the following (FIG. 3): The method starts S300 and will first try to determine S302 whether the print head has a loose nozzle plate. More detail on making this determination is provided below with respect to FIG. 4. If it does (yes-branch) the method will proceed with making S312 the final determination that the print head health is non-optimal and that the print head is to be considered for replacement (“Print Head Health=non-optimal”). After that determination the method ends S314.

Going back to the test to determine S302 whether the nozzle plate is loose, if it is determined that the nozzle plate is not loose (no-branch), the method proceeds to the next step wherein it determines S304 if the print head has been used with expired ink. Ink dries out as it ages. Aged ink introduces a high chance of (partially) dried ink clogging the nozzles of the print head in a permanent way. Therefore, if it is concluded that expired ink has been used (yes-branch) the method proceeds again to setting S312 the print head health to “non-optimal” as described above with respect to a loose nozzle plate having been determined. If it is determined instead that no expired ink has been used, the method proceeds (no-branch) to determining S306 whether any specific errors have been generated by or for the print head.

Specific errors may be generated if internal components of the print head fail, for example the NTC thermistor of an ink reservoir in the print head may fail, causing the print head to log a specific error. If the method determines S306 that such unrecoverable errors have occurred, processing again proceeds to setting S312 the print head health to “non-optimal”. If no unrecoverable errors have occurred (no-branch), the method proceeds with determining S308 whether the number of uncompensatable failing nozzles exceeds a threshold.

In a printer performing NFD (Nozzle Failure Detection) the printer keeps track of nozzles that fail to jet ink. A nozzle failing to jet ink may be failing permanently, or it may be failing temporary as in the nozzle failure may be resolved by performing print head maintenance (for example flushing the print head with ink). In both cases the printer may also be performing NFC (Nozzle Failure Correction) wherein the printer compensates for a failing nozzle by having neighbouring nozzles jet instead of the failing nozzle, or jet larger droplets instead. In a multi-pass print process another nozzle that passes over the same media location that needs an ink droplet may take over instead. However, if too many nozzles are failing (for example multiple subsequent nozzles are failing), it may be impossible to compensate every failing nozzle.

When the method determines S308 that the number of uncompensatable, failing nozzles exceeds a predetermined threshold, for example 1%, 2%, or 5% of the number of nozzles in the print head, the uncompensatable failing nozzles are considered to affect the print quality in an unacceptable way. The method will thus proceed (yes-branch) to setting S312 the print head health to “non-optimal”. If the number of uncompensatable, failing nozzles does not exceed the predetermined threshold (no-branch), the method proceeds to setting S310 the print head health to being sufficient (“Print Head Health=okay”), and processing finally ends S314.

Note that determining uncompensatable failing nozzles is different than determining a loose nozzle plate and uses different criteria, although both are based on information about failing nozzles. For example, if half of the outer nozzles are failing, a loose nozzle plate is probably the case and the print head should be replaced. However, if those failing nozzles were not specifically outer nozzles, but were more or less distributed over the whole print head, print quality might not necessarily be an issue (as long as most of them can be compensated).

It is noted that the four tests described in FIGS. 3, S302, S304, S306, and S308, may also be executed in any other order.

Furthermore, in a more simple embodiment the determination in step S308 does not trigger on the number of uncompensatable failing nozzles, but simply on the number of failing nozzles. With increasing numbers of failing nozzles, the number of failing nozzles that can be compensated decreased. From a print head health perspective considering a number of uncompensatable failing nozzles instead of just a number of failing nozzles only makes sense for a low threshold.

As described above, a determination is made whether the nozzle plate of the print head may be loose (FIG. 3, S302). This determination is performed as follows (FIG. 4): The method starts S400 and will retrieve S402 nozzle acoustic feedback for the last n prints. The last n prints are the last n non-calibration prints. Next, for each of the last n prints the number of occurrences of nozzle failure states will be counted S404 for the outer nozzles of the print head. For example, only ⅛-th, 1/16-th, or 1/32-th of the nozzles on the one side and a similar fraction of the nozzles on the other side are counted as a nozzle plate will typically first start to come loose at the outer sides of the print head.

For each of the last n prints the weighted sum of these occurrences will be calculated: wₒₚₑₙ fₒₚₑₙ+wₐᵢᵣ fₐᵢᵣ+w_{dev} f_{dev}, wherein fₛₜₐₜₑ denotes the number of occurrences of the failure state state and wₛₜₐₜₑ the weight for the failure state.

Typically, an open circuit (“open”) failure state will be a stronger indication of a loose nozzle plate than an air at nozzle (“air”) failure state. A deviating nozzle (“dev”) failure state is the weakest indicator of a loose nozzle plate among these failure states.

Example weights for the failure states are:

| Weight | Weight value |
|---|---|
| Wₒₚₑₙ | 3 |
| Wₐᵢᵣ | 1 |
| W_{dev} | 0.5 |

For each print, it is compared whether the weighted sum exceeds a threshold x, for example x=8. The number of times the weighted sum exceeds the threshold x is counted S408. Subsequently, a determination is made S410 whether the number of prints exceeding the threshold x is more than a threshold y per cent of the prints under consideration. If this number of prints does exceed y per cent of the prints considered, (yes-branch) the nozzle plate is considered S414 to be loose. If the number of prints with a weighted sum exceeding the threshold x does not exceed y per cent of the prints considered (no-branch), the nozzle plate is not considered loose S412. Therewith the determination whether the print head has a loose nozzle plate ends S416.

Above the weighted sum is calculated for each print. Alternatively, the weighted sum can be calculated for each swath, or for a number of swaths. In another alternative the calculation is still done per print, but only a limited number of swaths are considered, for example the first and the last swath of the print. The reason to consider a limited number of swaths is to reduce the computational load as the amount of data to be processed increases significantly with every swath. Considering a first and a last swath of a print is based on the assumption that if a nozzle fails during both a first swath and a last swath, it is quite likely that it failed during all swaths in between.

The determination whether the nozzle plate is loose is described in respect to FIG. 4 as being based on the nozzle acoustic feedback. It is also be possible to use the NFD information instead of the nozzle acoustic feedback, for example if the NFD information is obtained from an inline scanner downstream of the print heads. This is more involved though as the inline scanner does not determine itself which dots on the print media were formed by which print head nozzles and therefore requires a further (complex) mechanism to make this determination. Furthermore, NFD based on an inline scanner does not provide the same level of detail as the nozzle acoustic feedback does.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. Print head health determining device, comprising:
a print head interface for connecting to a print head or log server and obtaining status information with regard to the print head;
a data processing device connected to the print head interface and configured to process the print head status information and determine a print head health; and
an output interface connected to the data processing device and configured to output the print head health; and
wherein the print head status information comprises one or more of:
nozzle acoustic feedback information,
information on the prior usage of expired ink, and
nozzle failure detection information; and
wherein the nozzle state of only a predetermined number of outer nozzles of a print head are considered for determining the print head health.

2. Print head health determining device according to claim 1, wherein the nozzle acoustic feedback information comprises for at least part of the nozzles of the print head a most likely nozzle state out of a multitude of nozzle states for a nozzle, including at least one state denoting normal jetting behaviour and at least one state denoting a failure state; and wherein the number of occurrences of one or more failure states is used to determine the print head health.

3. Print head health determining device according to claim 2, wherein the failure states comprise at least one of:
an open circuit (“open”) state,
an air at nozzle (“air”) state, and
a deviating nozzle (“dev”) state.

4. Print head health determining device according to claim 2, wherein the print head health is based on a weighted sum of the occurrences of the failure states in one or more swaths exceeding a predetermined threshold.

5. Print head health determining device according to claim 1, wherein if the information on the prior usage of expired ink indicates that the print head has been used with expired ink, the print head health is determined as non-optimal.

6. Print head health determining device according to claim 1, wherein the nozzle failure detection (NFD) information comprises a number of print head nozzles that is failing, and if it is determined that the number of failing nozzles or the number of uncompensatable nozzles that remain after applying nozzle failure correction (NFC) exceeds a threshold, determining a print head health as non-optimal.

7. Printer controller comprising the print head health determining device of claim 1.

8. Printer controller comprising the print head health determining device of claim 6.

9. Printer fleet management server comprising the print head health determining device of claim 1.

10. Printer fleet management server comprising the print head health determining device of claim 6.

11. Method for determining the health of a print head, comprising the steps of:
obtaining status information from a print head;
processing the print head status information
determining a print head health; and
outputting the print head health; and
wherein the print head status information comprises one or more of:
nozzle acoustic feedback information,
information on the prior usage of expired ink, and
nozzle failure detection information; and
wherein the print head health is based on a weighted sum of the occurrences of the failure states in one or more swaths exceeding a predetermined threshold.

12. Method according to claim 11, wherein the nozzle acoustic feedback information comprises for at least part of the nozzles of the print head a most likely nozzle state out of a multitude of nozzle states for a nozzle, including at least one state denoting normal jetting behaviour and at least one state denoting a failure state; and
wherein in the processing step the number of occurrences of one or more failure states is used to determine the print head health as non-optimal.

13. Method according to claim 12, wherein the failure states comprise at least one of:
an open circuit (“open”) state,
an air at nozzle (“air”) state, and
a deviating nozzle (“dev”) state.

14. Method according to claim 11, wherein the nozzle state of only a predetermined number of outer nozzles of a print head are considered for determining the print head health.

15. Method according to claim 11, wherein the nozzle failure detection (NFD) information comprises a number of print head nozzles that is failing, and if it is determined that the number of failing nozzles or the number of uncompensatable nozzles that remain after applying nozzle failure correction (NFC) exceeds a threshold, determining a print head health as non-optimal.

16. A computer program product embodied on a non-transitory computer readable medium that, if executed on a processor connected to a print head, performs the steps of the method of claim 11.

17. A computer program product embodied on a non-transitory computer readable medium that, if executed on a processor connected to a print head, performs the steps of the method of claim 12.

18. A computer program product embodied on a non-transitory computer readable medium that, if executed on a processor connected to a print head, performs the steps of the method of claim 13.

19. A computer program product embodied on a non-transitory computer readable medium that, if executed on a processor connected to a print head, performs the steps of the method of claim 14.

20. A computer program product embodied on a non-transitory computer readable medium that, if executed on a processor connected to a print head, performs the steps of the method of claim 15.
